(19) United States
(12) Patent Application Publication
(10) Pub. No.: US 2011/0225966 A1
(43) Pub. Date: Sep. 22, 2011

(54) HEAT PUMP

(76) Inventor: Soo Joh Chae, Seoul (KR)

(21) Appl. No.: 13/131,862

(22) PCT Filed: Nov. 27, 2009
(86) PCT No.: PCT/KR09/07037

§ 371 Date: May 27, 2011

(30) Foreign Application Priority Data
Nov. 27, 2008 (KR) 10-2008-0118894
Nov. 27, 2008 (KR) 10-2008-0118905

(51) Int. Cl. F02G 1/043

(52) U.S. Cl. 60/517

(57) ABSTRACT

Disclosed is a heat pump which follows an intermediate form between an ideal Carnot cycle and a Stirling cycle and which, as the same time, has high thermal efficiency as heat is transferred from low temperature to high temperature due to a heat cycle caused by the compression and expansion of a gas by means of an external motive force. The heat pump can comprises: a cylinder which accommodates a working gas on the inside; a heat discharge part which is located at the front end part of the cylinder, and which discharges, to the outside, heat created in the working gas during the compression of the working gas; a heat absorption part which is located at the lower end part of the cylinder, and which is formed in such a way that the working gas absorbs heat from the outside when the working gas expands; a piston which is housed inside the cylinder in such a way as to describe a linear reciprocating motion, and which is formed with an opening in such a way that the working gas makes direct contact with either the heat discharge part or the heat absorption part, and which includes the compression and the expansion of the working gas; and drives part which supplies a motive force to the piston in such a way that the piston moves with a linear reciprocating motion relative to the cylinder.

### TECHNICAL FIELD

The present invention relates to a heat pump, and in particular to a heat pump which makes it possible to transfer heat from low temperature to high temperature with the aid of a heat cycle based on compression and expansion of working gas by driving force from the outside in such a way similar to an ideal Carnot cycle.

### BACKGROUND ART

Carnot engine is directed to an ideal heat efficiency engine without having any heat loss. All kinds of engines cannot exceed the engine efficiency of Carnot engine. The external combustion engine has relatively high heat efficiency as compared to the internal combustion engine. Among a variety of engines, Stirling engine has high heat efficiency similar to Carnot cycle, along with less vibration and noises.

All kinds of heat engines like Carnot engine and Stirling engine are directed to obtaining heat transferring from high temperature to low temperature. On the contrary, external driving force is provided to heat engine in reverse direction cycle, for thereby compressing and expanding gas, which results in heat pump. As a representative of the heat pump, there is Stirling refrigerator.

However the Stirling refrigerator has a bulky size and a complicated structure, which leads to high manufacture cost and high tech levels. Due to difficult maintenance, it is used at very limited field. A common refrigerator is directed to cooling using evaporation heat of liquid made by high pressure condensing common coolant on the basis of complicated heat circulation like a compressor or the something. In this case, there are problems such as environmental problems of coolants and limit in the cooling temperature based on coolants.

### DISCLOSURE OF INVENTION

Accordingly, it is an object of the present invention to provide a heat pump which makes it possible to produce high heat efficiency in such a way similar to a heat cycle of an intermediate type between Carnot cycle and Stirling cycle, while overcoming the problems encountered in the conventional art.

It is another object of the present invention to provide a hat pump (refrigerator) which has a simple structure and a low manufacture cost in such a way different from a conventional refrigerator having a complicated heat circulation structure in which a phase conversion is obtained via a compressor/refrigerator.

It is obvious that the above objects are not limited thereto, and the non-mentioned other objects might be well understood to those who skilled in the art.

To achieve the above objects, there is provided a heat pump, comprising a cylinder which contains working gas in its interior; a heat radiation part which is positioned at a front end portion of the cylinder and radiates heat to the outside, the heating being generated in the working gas when the working gas is compressed; a heat absorption part which is positioned at a rear end portion of the cylinder and allows the working gas to externally absorb the heat when the working gas is expanded; a piston which linearly reciprocates in the interior of the cylinder and has an opening allowing the working gas to directly contact with the heat radiation part or the heat absorption part and performs the compression and expansion of the working gas; and a driving part which provides a driving force to the piston to allow the piston to linearly reciprocate with respect to the cylinder.

The driving part converts externally supplied electric energy into a mechanical energy for a linear reciprocation movement to the piston.

The driving part includes a magnet provided at an outer surface of the piston, and a coil which is wound on an outer surface of the cylinder and allows the piston to linearly reciprocate depending on the change of magnetic flux lines of the magnet when external current is applied.

The driving part includes a motor which generates rotational force; a crank arm which is connected to the rotary shaft of the motor; and a connecting rod which connects the piston and the crank arm and transfers a driving force depending on the rotation of the motor to the piston so that the piston can linearly reciprocate.

The cylinder includes an insulation part disposed between the heat radiation part and the heat absorption part.

The cylinder has a front end portion which is open to the outside, and the heat pump includes a cylinder head part engaged to the front end portion of the cylinder to seal the front end portion of the cylinder.

The piston includes a hollow part at is front end portion, and the cylinder head part includes a head cover engaged to the front end portion of the cylinder, and a protrusion part which is protruded from the head cover head is spaced apart from an inner side surface of the cylinder by a certain distance and has a guide groove into which the front end portion of the piston is inserted.

The heat radiation part and the heat absorption part are installed at an outer surface of the cylinder in ring shapes.

There is further provided a cooling part for cooling heat from the heat radiation part.

The cooling part includes a cooling fin formed at an outer diameter portion of the heat radiation part; and a cooling fan for cooling by supplying air to the cooling fin.

The cooling part includes a cooling tube wound on an outer diameter portion of the heat radiation part; and a cooling pump for supplying cooling water to the cooling tube.

There is further provided a cooling circulation part for circulating external air cooled by the heat absorption part.

The cooling circulation part includes a circulation path chamber for providing an air circulation path for external air to flow via the heat absorption part; and a wind blowing part which is provided at the circulation path chamber and forcibly circulates the air.

There is further provided a recovery means for providing a recovery force to the piston so that the piston can keep reciprocating.

### Effects

The heat pump according to the present invention has at least one of the following advantageous effects.

First, it is possible to obtain high hat efficiency like a conventional

Stirling refrigerator on the basis of a way similar to a heat cycle of an intermediate type between Carnot cycle and Stirling cycle.

Second, being different from a conventional refrigerator having a complicated heat circulation structure like a compressor or something, the heat pump according to the present invention is basically directed to cooling with an aid of a gas compression and expansion without using a specific coolant, the system can be made in a simple structure along with an easier maintenance.

Third, since a high pressure compression does not occur for liquefaction of coolant unlike a conventional compressor, noses and vibration are less.

Fourth, the present invention is like an air-tight structure in which a free piston reciprocates in a sealed cylinder, so high cooling efficiency per unit volume can be obtained with the aid of a high pressure gas operation.

Fifth, the gas filled in the spring part of the lower side of the piston is compressed and expanded with the aid of reciprocation of a piston, so it functions like a gas spring, thus obtaining more efficient elastic movements.

The above advantageous effects of the present invention are not limited thereto, and it is obvious that such effects can be well understood to those who skilled in the art.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating a heat pump according to an embodiment of the present invention;

FIG. 2 is a cross sectional view taken along line II-II of FIG. 1;

FIG. 3 is a perspective view illustrating a cylinder of a heat pump according to an embodiment of the present invention;

FIG. 4 is a cross sectional view of a cylinder of a heat pump according to an embodiment of the present invention;

FIG. 5 is a perspective view of a piston of a heat pump according to an embodiment of the present invention;

FIG. 6 is a cross sectional view of a piston of a heat pump according to the present invention;

FIGS. 7 and 8 are example views of an embodiment of a cooling part of a heat pump according to an embodiment of the present invention;

FIG. 9 is an example view of an embodiment of a cooling circulation part of a heat pump according to an embodiment of the present invention;

FIGS. 10 to 13 are example views for sequentially describing the is operations of a heat pump according to an embodiment of the present invention;

FIGS. 14 and 15 are graphs of a cooling cycle of a heat pump according to an embodiment of the present invention;

FIG. 16 is a cross sectional view of a heat pump according to another embodiment of the present invention;

FIG. 17 is a perspective view of a heat pump according to further another embodiment of the present invention;

FIG. 18 is a cross sectional view taken along like III-III of FIG. 17;

FIG. 19 is a perspective view of a piston of a heat pump according to further another embodiment of the present invention;

FIG. 20 is a cross sectional view of a piston of a heat pump according to further another embodiment of the present invention; and

FIGS. 21 to 24 are example views for sequentially describing an operation of a heat pump according to further another embodiment of the present invention.

<Brief descriptions of reference numerals of the major elements>

| | | | |
|---|---|---|---|
| 10, 20, 30: | heat pump | 100: | cylinder |
| 120: | cylinder head part | 121: | head cover |
| 123: | protrusion | 124: | guide groove |
| 140: | adiabatic part | 200: | piston |
| 212: | opening | 220: | piston ring |
| 300: | heat discharge part | 310, 320: | cooling part |
| 400: | heat absorption part | 410: | cooling circulation part |
| 500, 600: | driving part | 510: | magnet |
| 520: | coil | 530: | current supply source |
| 700: | recovery member | | |

### MODES FOR CARRYING OUT THE INVENTION

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

The heat pump according to a preferred embodiment of the present invention will be described with reference to the accompanying drawings. In the course of the descriptions of the present invention, what the descriptions might be understood making the subject matters of the present invention unclear will be omitted from their descriptions.

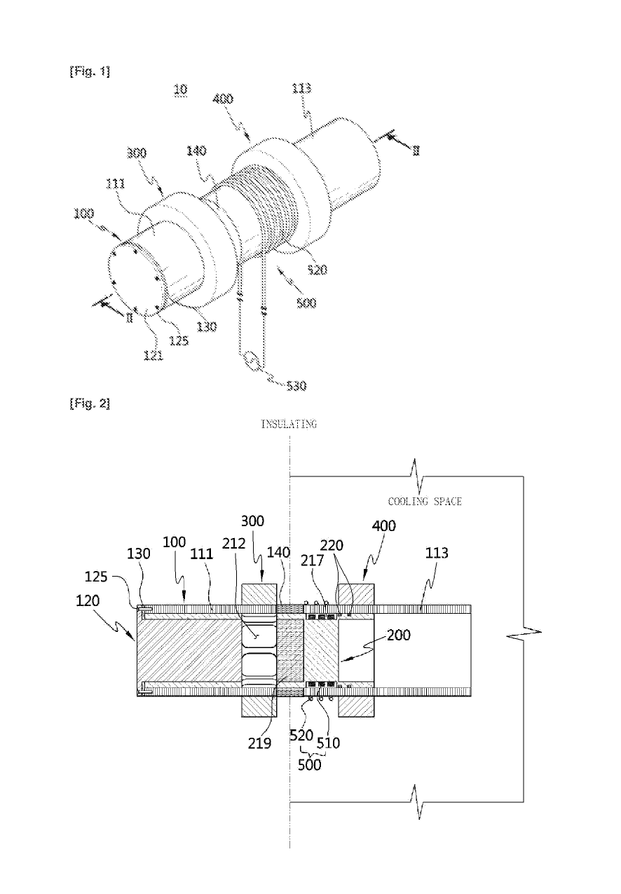

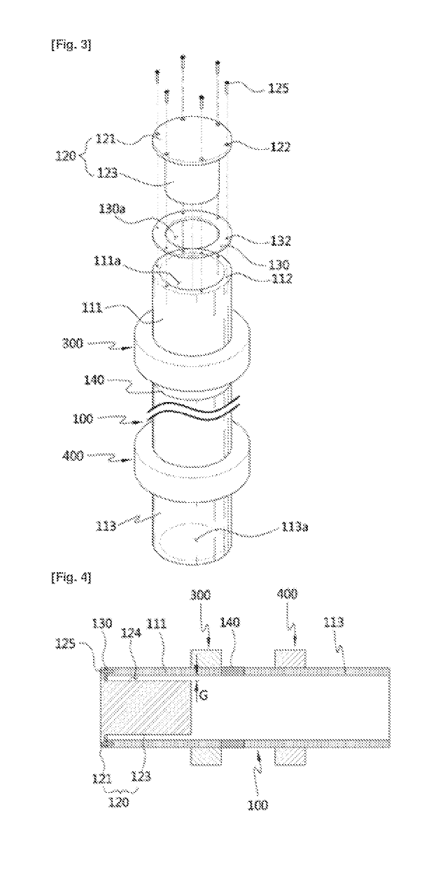

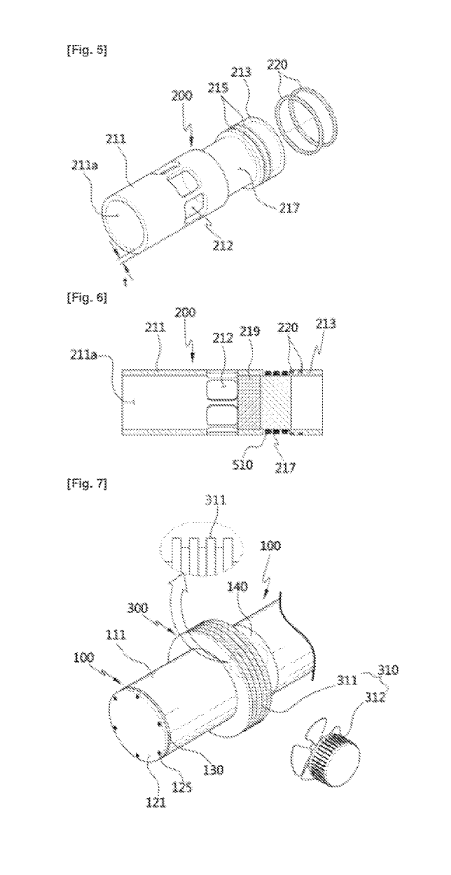

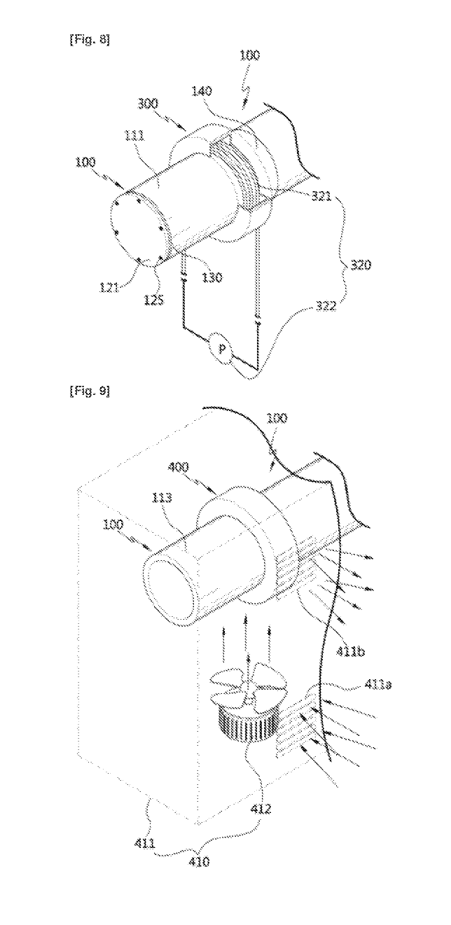

FIG. 1 is a perspective view illustrating a heat pump according to an embodiment of the present invention, FIG. 2 is a cross sectional view taken along line II-II of FIG. 1, FIG. 3 is a perspective view illustrating a cylinder of a heat pump according to an embodiment of the present invention, FIG. 4 is a cross sectional view of a cylinder of a heat pump according to an embodiment of the present invention; FIG. 5 is a perspective view of a piston of a heat pump according to an embodiment of the present invention; and FIG. 6 is a cross sectional view of a piston of a heat pump according to the present invention.

As shown in FIGS. 1 to 6, the heat pump 10 according to an embodiment of the present invention comprises a cylinder 100, a piston 20, a to heat discharge part 300, a heat absorption part 400 and a driving part 500.

The cylinder 100 is made in a cylindrical shape and is filled with working gas such as hydrogen or helium.

According to the present invention, the cylinder 100 might be made with its front end 111 being open to the outside, provided that such construction is is just an example, and the front end of the same might be closed.

The open part 111a of the front part 111 of the cylinder 100 might be sealed by the cylinder head part 120, and the cylinder head part 120 is formed with a head cover 121 and a protrusion part 123.

The head cover 121 is formed of a circular plate with a certain thickness and has the same or larger diameter as the diameter of the front end part 111 of the cylinder 100. The head cover 121 is formed with a plurality of bolt holes 122 along an edge portion, matching with the bolt holes 112 formed at the front end part 111 of the cylinder 100 and are engaged to the front end part 111 of the cylinder 100 using the bolt 125.

In this case, a circular sealing member 130, for example, a rubber packing, might be installed between the head cover 121 and the front end part 111 of the cylinder 100, thus enhancing sealing performance of the cylinder 100 and preventing the working gas from leaking from the interior of the cylinder 100 to the outside. The sealing member 130 is formed of a circular hollow part 130a for receiving the protrusion part 123 of the cylinder head part 120 at its center portion, with a bolt hole 132 being formed at an edge portion for allowing the bolt 125 to pass through.

The protrusion part 123 is protruded in a circular column shape opposite to the piston 200 at one side of the head cover 121 and is inserted into the open part 111a formed at the front end part 111 of the cylinder 100. The protrusion part 123 is spaced apart by a certain distance G from the inner side of the front end part 111 of the cylinder 100, thus forming a guide groove 124 into which the front end part 211 of the piston 200 is inserted. In this case, the distance G between the protrusion part 123 and the cylinder 100 corresponds to the thickness of the front end part 211 of the piston 200.

In this case, the length of the protrusion part 123, namely, the length of the guide groove 124 is almost same as the length from the front end of the piston 200 to the front end of the opening 212 so that the opening 212 of the piston 200 can be positioned at the heat radiation part 300 when the working gas is maximum compressed, namely, when the volume of the working gas is minimum.

The cylinder 100 might be formed of an opening 113a at the rear end 113 for receiving the piston 200 therein.

The cylinder 100 is formed of an adiabatic part 140 for insulating the heat between the heat radiation part 300 and the heat absorption part 400. In this case, the adiabatic part 140 might be disposed between the heat radiation part 300 and the heat absorption part 400.

The cylinder 100 is made of stainless steel, and the adiabatic part to 140 of the cylinder 100 is made of ceramic, silica or something.

The piston 200 is accommodated in the interior of the cylinder 100 to reciprocate with the aid of the driving part 500, thus compressing and expanding the working gas sealed between the cylinder 100 and the piston 200. In the embodiment of the present invention, what it is applied to the free piston 200 has been descried, but it is not limited thereto, namely, it might be applied to various types of pistons.

The piston 200 is formed in a cylindrical shape having a diameter corresponding to the inner diameter of the cylinder 100, and the front end of the piston 200 is preferably made of a heat insulation material such as metal or ceramic having a low heat conduction ratio.

The piston 200 is formed with a hollow part 211a at the front end part 211 and is characterized in that its interior is sealed starting from the rear side of the opening 212. The protrusion 123 of the cylinder head part 120 might be inserted into the hollow part 211a. A heat insulation member 219 might be installed at a rear portion of the opening 212.

The piston 200 is formed allowing an opening 212 to directly come into contact with the heat radiation part 300 or the heat absorption part 400. It is preferred that a plurality of openings 212 might be formed along an outer diameter at the front end part 211 of the piston 200. The opening 212 might be formed in a circular shape, a rectangular shape or other shapes.

The front end part 211 of the piston 200 preferably has a thickness corresponding to the distance G of the guide groove 124 formed between the inner wall of the cylinder 100 and the protrusion 123 of the head part 120. In addition, the front end part 211 of the piston 200 preferably has a length which allows the working gas not to contact with the heat radiation part 300 when the volume of the working gas is maximum, namely, the vibration width of the piston 200 is maximum. For example, the front end part 211 of the piston 200 has a length enough to substantially cover the heat radiation part 300, the adiabatic part 140 and the heat absorption part 400, assuming that their lengths are same. In this case, the front end part 211 of the piston 200 preferably has the same length as the length of the protrusion 123 of the cylinder head part 120, namely, the length of the guide groove 124.

The piston 200 might be formed with a magnet mounting groove 217 at a rear outer surface of the front end part 211 for mounting the magnet 510 which will be described later.

At least one piston ring 220 might be installed at a rear end part 213 of the piston 200 so as to seal the portion where the inner wall of the cylinder 100 and the piston 200 both come into contact with each other, for which at least one piston ring mounting groove 215 is formed at an outer surface of the piston 200 for reliably mounting and fixing the piston ring 220. Since the piston ring 220 is positioned at an inner side of the heat absorption part 400 of the cylinder 100 when the piston 200 reciprocates, a material operating as a low temperature like Teflon ring might be used. In the present invention, the construction that the piston ring 220 is adapted has been described, but it is not limited thereto. A fixing ring might be installed at an inner wall of the cylinder 100 in a vertical bearing type instead of the piston ring 220.

The heat radiation part (heat source) 300 is positioned at a front end part 111 of the cylinder 100, thus radiating heat from the working gas to the outside when the working gas is compressed. The heat radiation part 300 is made of a metallic material which well transfers heat and can be installed at an outer surface of the cylinder 100 in a ring shape, which is not limited thereto. Various medications are possible.

The heat pump 10 according to the present invention further includes cooling pats 310 and 320 for cooling the heat from the heat radiation part 300.

As shown in FIG. 7, the cooling part 310 comprises a cooling fin 311 formed at an outer surface of the heat radiation part 300 of the cylinder 100, and a cooling fan 312 supplying air to the cooling fin 311, thus cooling, which might be formed in an air cooling system. It is preferred that the cooling fin 311 is formed in a protrude shape, thus increasing the area contacting with the air for a quick cooling under atmosphere environment.

As shown in FIG. 8, the cooling part 320 comprises a cooling tube 321 wound on an outer surface of the cylinder 100, and a cooling pump 322 supplying cooling water to the cooling tube 321, which might be formed in a water cooling system, provided that the cooling tube 321 might be wound on an outer surface of the heat radiation part 300 of the cylinder 100.

The heat absorption part (heat sink) 400 is positioned at a rear end side 113 of the cylinder 100, thus allowing the working gas to absorb heat from the outside when the working gas expands. The heat absorption part 400 can be installed in a ring shape at the outer surface of the cylinder 100, which is not limited thereto.

The heat pump 10 according to the present invention further includes a cooling circulation part 410 for circulating external air cooled by means of the heat absorption part 400.

As shown in FIG. 9, the cooling circulation part 410 comprises a circulation path chamber 411 providing an air circulation path to allow the external air to flow via the heat absorption part 400, and a wind blowing fan 412 disposed in the interior of the circulation path chamber 411 for forcibly circulating the air. The circulation path chamber 411 includes a suction port 411a disposed at a lower side for sucking air, and a discharge port 411b for discharging the air cooled by the heat absorption part 400.

The driving part 500 is directed to providing a driving force to the piston 200, thus allowing the piston 200 to compress and expand the working gas. The piston 200 receives a driving force from the driving part 500 and allows the piston 200 to reciprocate with respect to the cylinder 100.

The driving part 500 according to the present invention is directed to converting the electric energy externally provided, into the mechanical energy to for a straight reciprocating movement of the piston 200 and is formed with a magnet 510, and a coil 520.

The magnet 510 is disposed at the piston 200, and it is preferable that a plurality of magnets 510 are provided in a longitudinal direction at the magnet mounting grooves 217 formed at a rear outer surface of the front end part 211 of the piston 200.

The coil 520 might be wound on the outer surface of the cylinder 100. In this case, the coil 520 is wound along the longitudinal direction of the cylinder 100, corresponding to the magnet 510 between the heat radiation part 300 and the heat absorption part 400.

The coil 520 is constituted to generate a driving force in such a way to allow the piston 200 to reciprocate on the basis of Fleming's left hand rule depending on the change of the magnetic flux line of the magnet 510 when current is applied from the external current supply source 530. In this case, the coil 520 with flowing electric current is placed perpendicular to the magnetic flux lines of the magnet 510. Here, Fleming's left hand rule is applied to the principle of the motor, the principle of which is known, so detailed descriptions will be omitted.

The current supply source 530 induces the changes in magnetic flux lines of the magnet 510 by repeatedly changing the directions of currents flowing at the coil 520, thus obtaining a straight reciprocation movement of the piston 200.

As shown in FIG. 2, when the current is supplied from the current supply source 530 to the coil 520 in a clockwise direction, the piston 200 moves to the front end portion 111 of the cylinder 100, namely, in a leftward direction, thus compressing the working gas. When the current flows in the reverse direction from the current supply source 530 to the coil 520, namely, when the is direction of flowing current changes, the piston 200 moves (right ward direction) to the rear end portion 113 of the cylinder 100, thus expanding the working gas.

As shown in FIGS. 10 to 15, the operation of the heat pump according to the present invention will be described.

FIGS. 10 to 13 are example views for sequentially describing the operations of a heat pump according to an embodiment of the present invention, and FIGS. 14 and 15 are graphs of a cooling cycle of a heat pump according to an embodiment of the present invention.

As shown in FIG. 10, the piston 200 is forced to move to the front end portion 111 of the cylinder 100 (in the drawings, leftward direction) until the volume of the working gas sealed in the space between the cylinder 100 and the piston 200 is minimized with the aid of the driving force of the driving part 500, the working gas is compressed at a high temperature.

In this case, the working gas comes into direct contact with the heat radiation part 300 via the opening 212 of the piston 200, thus radiating heat energy Q1 (high temperature compression procedure \hat{2}→\hat{1} FIG. 14).

The heat energy Q1 emitted from the heat radiation part 300, as shown in FIGS. 7 and 8, can be cooled by the cooling parts 310 and 320. The heat transfer between the heat radiation part 300 and the heat absorption part 400 is blocked by the adiabatic part 140 arranged between the heat radiation part 300 and the heat absorption part 400.

As shown in FIG. 11, when the piston 200 moves toward the rear end part 113 of the cylinder 100 (in the right ward direction in the drawings), the working gas exposed to the heat radiation part 300 is cooled and expanded, thus decreasing the temperature.

In this case, the working gas radiates the heat energy Q4 via the heat radiation part 300 (high temperature expansion procedure \hat{1}→\hat{4} of FIG. 14).

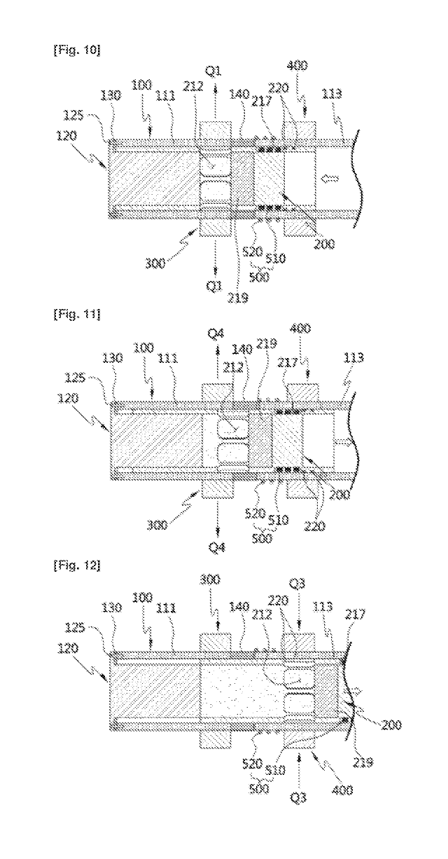

As shown in FIG. 12, when the piston 200 is forced to move to the rear end part 113 of the cylinder 100 (in the rightward direction in the drawing) until the volume of the working gas sealed in the space between the cylinder 100 and the piston 200 is maximized, the working gas becomes a low temperature expansion state.

In this case, the opening 212 of the piston 200 comes into direct contact with the heat absorption member 400, thus allowing the working gas to absorb the heat energy Q3 (low temperature cooling and expansion procedure \hat{4}→\hat{3} of FIG. 14). So, since the working gas absorbs the surrounding heat energy Q3 of the heat absorption part 400, cooling effects occur, and the air cooled by the heat absorption part 400 can circulate by means of the cooling circulation part 410 as shown in FIG. 9.

As shown in FIG. 13, the low temperature expanded working gas keeps absorbing the heat energy Q3, and the heat radiation part 300 is closed, and only the heat absorption part 400 contacts, so the working gas is heated and compressed.

Part of the heat energy Q2 is absorbed into the interior of the working gas (low temperature cooling and compression procedure \hat{3}→\hat{2} of FIG. 14).

When the length of the adiabatic part 140 disposed between the heat radiation part 300 and the heat absorption part 400 is longer than the length of the opening 212 of the piston 200, adiabatic part (the procedures of \hat{2}→\hat{2}′, \hat{4}′→\hat{4} of FIG. 14) is present, and the entire heat cycles are obtained in the sequences of \hat{1}→\hat{2}→\hat{2}′→\hat{3}→\hat{4}′→\hat{4}→\hat{1} of FIG. 14.

When the length of the adiabatic part 140 is same as the length of the opening 212 of the piston 200, the ideal reverse heat cycle like \hat{2}=\hat{2}′, \hat{4}=\hat{4}′ without having adiabatic section shown in FIG. 15 is applied.

When the length of the adiabatic part 140 is shorter than the length of the opening 212 of the piston 200, since the opening 212 comes into contact with the heat radiation part 300 and the heat absorption part 400 at the same time, so the heating and cooling of the working gas concurrently occur, thus obtaining similar adiabatic effects. In this case, the heat cycle (not shown) is similar to the cycle of \hat{1}→\hat{2}→\hat{2}′→\hat{3}→\hat{4}′→\hat{4}→\hat{1} of FIG. 14.

The heat pump 10 according to the present invention is is characterized in that working gas such as hydrogen or helium gas is sealed in the space formed between the cylinder 100 and the piston 200, and the work of |W| is externally applied to the working gas with the aid of external linear driving force. As shown in FIGS. 10 to 15, the cooling work is performed around the heat absorption part 400 via the procedures of absorbing the heat energy of Q2 and Q3 from the heat absorption part 400 and radiating the heat energy of Q1 and Q4 to the heat radiation part 300.

The heat efficiency of the heat pump 10 according to the present invention is shown in the following formula 1.

$$e = \frac{{Q}_{out}}{W} = \frac{{Q}_{1} + {Q}_{4}}{{Q}_{1} + {Q}_{4} - {Q}_{2} - {Q}_{3}} = 1 / ( 1 - \frac{{Q}_{2} + {Q}_{3}}{{Q}_{1} + {Q}_{4}} ) \\ ( ≃ 1 / ( 1 - \frac{{T}_{c}}{{T}_{h}} ) ) \qquad Mathematical formula 1$$

As shown in the formula 1, the heat pump 10 according to the present invention has an intermediate characteristic between Carnot engine, ideal heat cycle, and Stirling engine, thus obtaining high heat efficiency. In addition, the heat pump 10 according to an embodiment of the present invention is directed to cooling with a compression and expansion of the gas without using a specific coolant as compared to a conventional refrigerator having a is complicated heat circulation structure like a conventional compressor or something, thus leading to a simple structure manufacture.

As not shown in the drawings, the heat pump might be constructed in a symmetrical shape, so the working gas stored in both front ends of the cylinder can be compressed and expanded using an external linear driving force, thus making the straight reciprocation movement of the piston more active, which results in enhancing heat efficiency of the heat pump.

FIG. 16 is a cross sectional view of a heat pump according to another embodiment of the present invention.

As shown in FIG. 16, the heat pump 20 according to another embodiment of the present invention comprises a cylinder 100, a piston 200, a heat radiation part 300, a heat absorption part 400, a driving part 500 and a recovery member 600.

In another embodiment of the present invention, the lengths of the adiabatic part 140 of the cylinder 100, the opening 212 of the piston 200 and the heat radiation part 300 are made same, and a recovery member 700 is further provided at the rear end of the piston 200. Except for the above construction, the remaining constructions are same as the embodiment of FIGS. 1 to 9. The same elements as the above embodiments will be given the same reference numerals, and the detailed descriptions on the same construction will be omitted.

According to the embodiment of the present invention, the lengths of the adiabatic part 140 of the cylinder 100, the opening 212 of the piston 200 and the heat radiation part 300 are all same. In this case, the heat pump 20 according to the present invention is, as shown in FIGS. 14 and 15, directed to absorbing the heat energy of Q2 and Q3 from the heat absorption part 400 and cooling the surrounding environments of the heat absorption part 400 via the procedure of emitting heat energy of Q1 and Q2 to the heat radiation part 300. Here, it is preferred that the length of the heat absorption part 400 is same as or slightly smaller than the lengths of the adiabatic part 140, the opening 212 and the heat radiation part 300.

A recovery force is needed to compress again the expanded working gas to allow the piston 200 to keep reciprocating. The recovery member 700 may be formed with a coil spring, a plate spring or a magnet generating a repulsive force between the sealed rear portion of the cylinder 100 and the rear end portion of the piston 200, thus providing a recovery force to the to piston 200 when the working gas is expanded. Here, the rear end of the cylinder 100 with the recovery member 700 functions like a gas spring compressing and expanding the sealed gas depending on the vibrations of the piston 200.

The heat pump 20 according to the present invention operates at the cooling cycle of FIGS. 14 and 15 like the heat pump 10 of the previously is embodiment of the present invention.

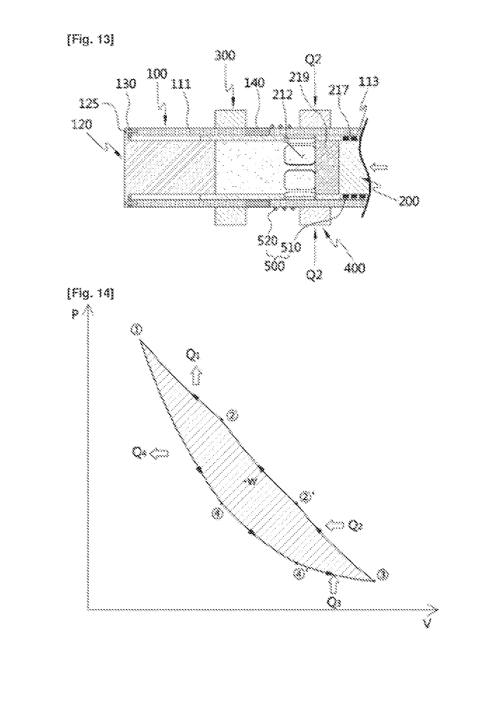

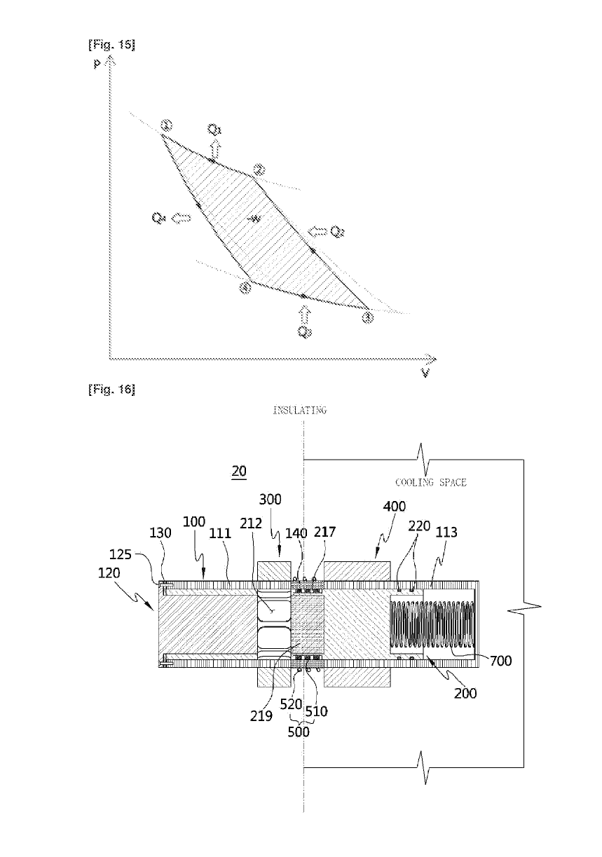

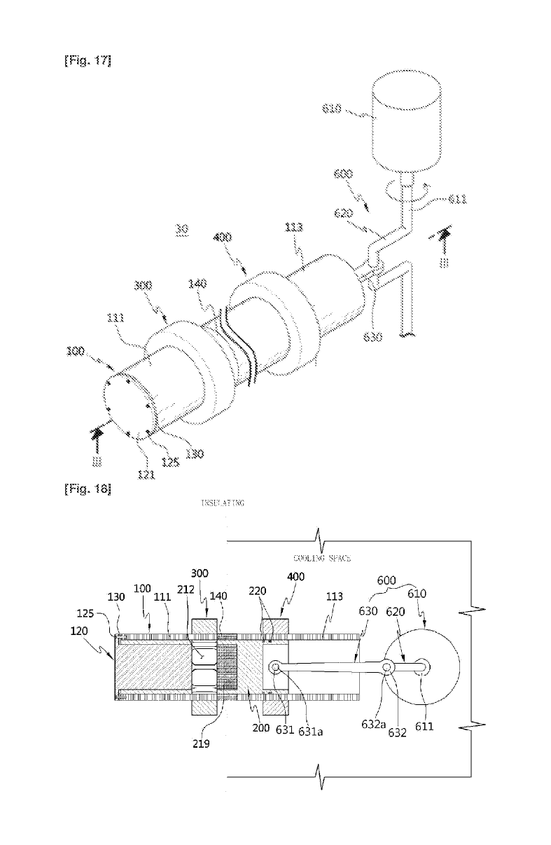

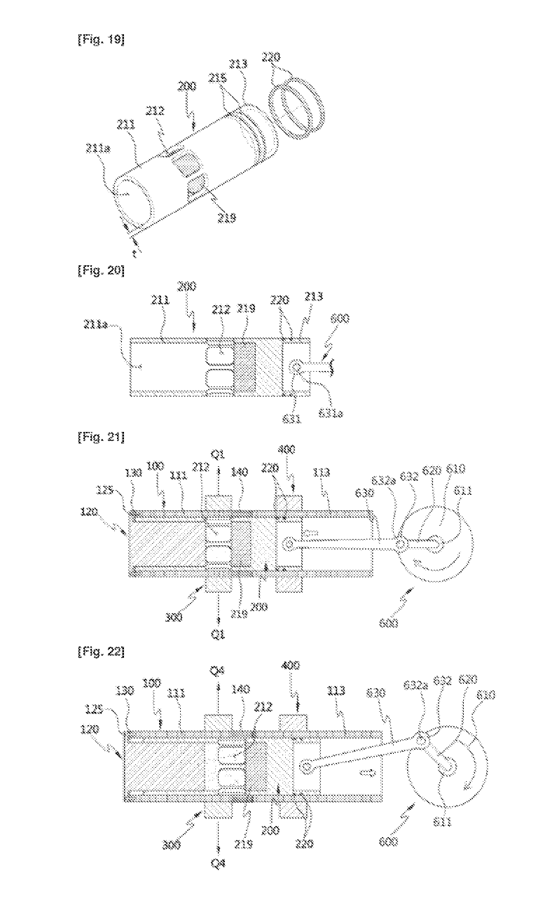

FIG. 17 is a perspective view of a heat pump according to further another embodiment of the present invention, FIG. 18 is a cross sectional view taken along like III-III of FIG. 17, FIG. 19 is a perspective view of a piston of a heat pump according to further another embodiment of the present invention, and FIG. 20 is a cross sectional view of a piston of a heat pump according to further another embodiment of the present invention.

As shown in FIGS. 17 to 20, the heat pump 30 according to the present invention comprises a cylinder 100, a piston 200, a heat radiation part 300, a heat absorption part 400 and a driving part 600.

The embodiments of the present invention will be described with reference to FIGS. 17 to 20. The same construction as the previous constructions (FIGS. 1 to 9) will be omitted. When there is not a specific description on each element, it means that the construction is same as the previous one (FIGS. 1 to 9), so the detailed descriptions will be omitted. The features according to the embodiments of the present invention will be described.

According to the present invention, the piston 200 might be connected with the rear end portion 213 with the aid of an end portion 631 and a hinge 631 a of a connecting rod 630.

The driving part 600 according to the present invention is directed to providing a driving force to the piston 200 to allow the piston 200 to perform a compression and expansion of the working gas. Namely, the piston receives a driving force from the driving part 600 and linearly reciprocates with respect to the cylinder.

In more details, the driving part 600 comprises a motor 610, a crank arm 620 and a connecting rod 630.

The motor 610 is fixed at an outer portion of the cylinder 100 by means of a fixing frame (not shown), thus generating rotational force. The rotary shaft 611 of the motor 610 operates a circular movement at the radius corresponding to the length of the crank arm 620 and converts into a linear movement via the connecting rod 630, thus allowing the piston 200 connected to the connecting rod 630 to linearly reciprocate.

As not shown in the drawings, in the heat pump with a plurality of cylinders 100, the directions of the crank arm 620 might be alternately formed at different angles.

The crank arm 620 is connected to the rotary shaft 611 of the motor 610, preferably, is vertically connected with respect to the rotary shaft 611.

The connecting rod 630 is directed to transferring a driving force based on the rotation of the motor 610 to the piston 200 to allow the piston 200 to linearly reciprocate. The connecting rod 630 is constituted with its one end 631 being engage to the rear end portion 213 of the piston 200 via a hinge 631a, with the other end 632 being connected to the crank arm 620 via a hinge 632a.

The connecting rod 630 receives a compression and tensional force, so it is configured to have a certain thickness to an extent to withstand such force and to have a length enough to smoothly transfer the driving force. The length of the connecting rod 630 is generally three or four times the length of the crank arm 620.

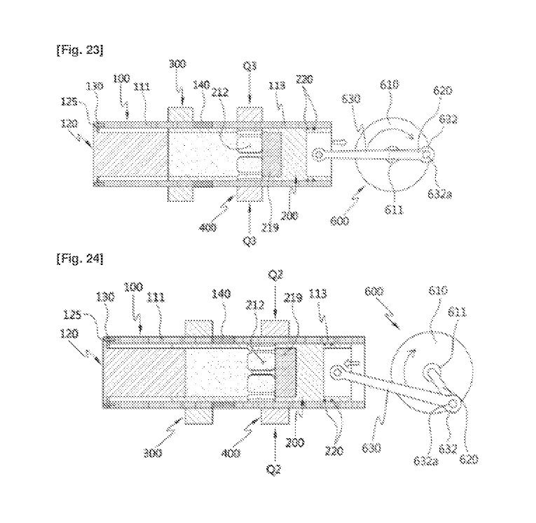

As shown in FIGS. 21 to 24, the driving part 600 is directed to providing a driving force to the piston 200 to allow the piston 200 to linearly reciprocate with respect to the cylinder 100. The heat pump 30 including the driving part 600 according to the present invention operates with the cooling cycle of FIG. 14 or 15 like the heat pump 10, 20 of the previous embodiment of the present invention.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A heat pump, comprising:
a cylinder which contains working gas in its interior;
a heat radiation part which is positioned at a front end portion of the cylinder and radiates heat to the outside, the heating being generated in the working gas when the working gas is compressed;
a heat absorption part which is positioned at a rear end portion of the cylinder and allows the working gas to externally absorb the heat when the working gas is expanded;
a piston which linearly reciprocates in the interior of the cylinder and has an opening allowing the working gas to directly contact with the heat radiation part or the heat absorption part and performs the compression and expansion of the working gas; and
a driving part which provides a driving force to the piston to allow the piston to linearly reciprocate with respect to the cylinder.

2. The heat pump according to claim 1, wherein said driving part converts externally supplied electric energy into a mechanical energy for a linear reciprocation movement of the piston.

3. The heat pump according to claim 2, wherein said driving part includes a magnet provided at an outer surface of the piston, and a coil which is wound on an outer surface of the cylinder and allows the piston to linearly reciprocate depending on the change of magnetic flux lines of the magnet when external current is applied.

4. The heat pump according to claim 1, wherein said driving part includes:
a motor which generates rotational force;
a crank arm which is connected to the rotary shaft of the motor; and
a connecting rod which connects the piston and the crank arm and transfers a driving force depending on the rotation of the motor to the piston so that the piston can linearly reciprocate.

5. The heat pump according to claim 1, wherein said cylinder includes an adiabatic part disposed between the heat radiation part and the heat absorption part.

6. The heat pump according to claim 1, wherein said cylinder has a front end portion which is open to the outside, and said heat pump includes a cylinder head part engaged to the front end portion of the cylinder to seal the front end portion of the cylinder.

7. The heat pump of claim 6, wherein said piston includes a hollow part at is front end portion, and said cylinder head part includes a head cover engaged to the front end portion of the cylinder, and a protrusion part which is protruded from the head cover head is spaced apart from an inner side surface of the cylinder by a certain distance and has a guide groove into which the front end portion of the piston is inserted.

8. The heat pump according to claim 1, wherein said heat radiation part and said heat absorption part are installed at an outer surface of the cylinder in ring shapes.

9. The heat pump according to claim 1, further comprising a cooling part for cooling heat from the heat radiation part.

10. The heat pump according to claim 9, wherein said cooling part includes a cooling fin formed at an outer diameter portion of the heat radiation part; and a cooling fan for cooling by supplying air to the cooling fin.

11. The heat pump according to claim 8, wherein said cooling part includes a cooling tube wound on an outer diameter portion of the heat radiation part; and a cooling pump for supplying cooling water to the cooling tube.

12. The heat pump according to claim 1, further comprising a cooling circulation part for circulating external air cooled by the heat absorption part.

13. The heat pump according to claim 12, wherein said cooling circulation part includes a circulation path chamber for providing an air circulation path for external air to flow via the heat absorption part; and a wind blowing part which is provided at the circulation path chamber and forcibly circulates the air.

14. The heat pump according to claim 1, further comprising a recovery means for providing a recovery force to the piston so that the piston can keep reciprocating.

15. The heat pump according to claim 2, wherein said cylinder includes an adiabatic part disposed between the heat radiation part and the heat absorption part.

16. The heat pump according to claim 3, wherein said cylinder includes an adiabatic part disposed between the heat radiation part and the heat absorption part.

17. The heat pump according to claim 4, wherein said cylinder includes an adiabatic part disposed between the heat radiation part and the heat absorption part.

18. The heat pump according to claim 2, wherein said cylinder has a front end portion which is open to the outside, and said heat pump includes a cylinder head part engaged to the front end portion of the cylinder to seal the front end portion of the cylinder.

19. The heat pump according to claim 3, wherein said cylinder has a front end portion which is open to the outside, and said heat pump includes a cylinder head part engaged to the front end portion of the cylinder to seal the front end portion of the cylinder.

20. The heat pump according to claim 4, wherein said cylinder has a front end portion which is open to the outside, and said heat pump includes a cylinder head part engaged to the front end portion of the cylinder to seal the front end portion of the cylinder.

21. The heat pump according to claim 2, wherein said heat radiation part and said heat absorption part are installed at an outer surface of the cylinder in ring shapes.

22. The heat pump according to claim 3, wherein said heat radiation part and said heat absorption part are installed at an outer surface of the cylinder in ring shapes.

23. The heat pump according to claim 4, wherein said heat radiation part and said heat absorption part are installed at an outer surface of the cylinder in ring shapes.

24. The heat pump according to claim 2, further comprising a cooling part for cooling heat from the heat radiation part.

25. The heat pump according to claim 3, further comprising a cooling part for cooling heat from the heat radiation part.

26. The heat pump according to claim 4, further comprising a cooling part for cooling heat from the heat radiation part.

27. The heat pump according to claim 2, further comprising a cooling circulation part for circulating external air cooled by the heat absorption part.

28. The heat pump according to claim 3, further comprising a cooling circulation part for circulating external air cooled by the heat absorption part.

29. The heat pump according to claim 4, further comprising a cooling circulation part for circulating external air cooled by the heat absorption part.

30. The heat pump according to claim 2, further comprising a recovery means for providing a recovery force to the piston so that the piston can keep reciprocating.

31. The heat pump according to claim 3, further comprising a recovery means for providing a recovery force to the piston so that the piston can keep reciprocating.

32. The heat pump according to claim 4, further comprising a recovery means for providing a recovery force to the piston so that the piston can keep reciprocating.
